(19) United States
(12) Patent Application Publication
(10) Pub. No.: US 2010/0306097 A1
(43) Pub. Date: Dec. 2, 2010

(54) DECENTRALIZED ENERGY SYSTEM AND METHOD FOR DISTRIBUTING ENERGY IN A DECENTRALIZED ENERGY SYSTEM

(75) Inventors: Martin Greiner, Neukeferloh (DE); Clemens Hoffmann, Ottobrunn (DE); Claus Kern, Altdorf (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/679,156

(22) PCT Filed: Jan. 10, 2008
(86) PCT No.: PCT/EP2008/050216

§ 371 Date: Mar. 19, 2010

(30) Foreign Application Priority Data
Sep. 21, 2007 (EP) 07018643.2
Sep. 21, 2007 (EP) 07018644.0
Sep. 21, 2007 (EP) 07018645.7
Sep. 21, 2007 (EP) 07018646.5

(51) Int. Cl. G06Q 50/00; G06F 1/26; G06Q 10/00; G06Q 40/00

(52) U.S. Cl. 705/37; 700/291; 700/297

(57) ABSTRACT

In order to ensure the robustness of decentralized energy systems and suitable distribution of the energy in such networks to a large number of energy consumption units, the novel energy system is provided with corresponding agents. At least one agent is associated with each energy consumption unit and/or energy generation unit in the decentralized energy system. The agents are interlinked in such a way that each agent can communicate with other agents in the energy system. Each change in the power output or power consumption requires a trade act, as a result of which large balance errors are avoided. In order to make this coupling between electrical and monetary acts practicable, current consumption contracts of an extremely wide variety can be drawn up between generators and consumers. The energy system is configured such that the energy is distributed in the system at least partially on the basis of monetary transactions arranged between the agents.

The invention relates to a decentralized energy network for distributing electrical energy, and a method for distributing the electrical energy in such an energy network.

The generation of energy in electrical energy networks today relies increasingly on a multiplicity of decentralized energy generation units in the form of small and medium-sized generator plants, e.g. photovoltaic plants, wind turbines and other decentralized and renewable energy generation plants. The number of these energy generation units is increasing continuously, resulting in a paradigm shift in the energy supply to the effect that the energy from energy generation units is distributed atomistically to energy consumers in the energy networks, without intermediate connection via a central energy supplier.

The invention therefore addresses the problem of providing a decentralized energy network which satisfies the above requirements and effectively distributes the energy of a plurality of energy consumption units and/or energy generation units depending on the energy demand and the energy that can be generated.

This problem is solved by the independent patent claims. Developments of the invention are defined in the dependent claims.

The inventive energy network comprises a plurality of energy consumption units and/or energy generation units, each of which is assigned at least one agent, the agents being networked together in such a way that each agent can communicate with other agents in the energy network. According to the invention, each exchange of the power output or power consumption requires a trade act, thereby avoiding large balance errors. In order to make this coupling between electrical and monetary act practicable, an extremely wide variety of current purchase contracts can be drawn up between generators and consumers. In this case, the energy network is designed in such a way that the distribution of electrical energy in the energy network is based at least partly on monetary transactions that are negotiated between the agents.

Using the inventive method, suitable distribution of the energy is therefore achieved on the basis of market mechanisms of supply and demand for energy. According to the invention, the monetary transactions represent in particular negotiated contracts between individual agents, said contracts defining the sale or purchase of specified amounts of energy. These contracts therefore also include the price at which the energy is sold by one agent and purchased by other agents.

According to the invention, the energy generation or energy provision is governed in a self-organizing manner, in that the agents include the functionality for negotiating monetary transactions. As a result, decentrally governed and self-organizing distribution of the energy in the network is achieved in a simple manner.

In a particularly preferred embodiment, the energy network can also link to other energy networks, and procure energy from other energy networks or provide surplus energy to other energy networks.

For the purpose of performing the above monetary transactions, each agent in the energy network preferably features a transaction unit, which automatically negotiates prices with other agents for the provision and/or the procurement of energy and enters into corresponding contracts. An agent which is assigned to a relevant energy consumption unit and/or energy generation unit preferably also comprises an energy measurement unit and/or energy control unit for measuring and/or controlling the energy that is consumed or provided by the relevant energy consumption unit and/or energy generation unit, in order thereby to determine whether or how much energy in the energy network can be offered for sale or should be acquired through purchase.

Each agent preferably comprises one or more communication interfaces, in particular an external communication interface for communication with other agents and/or an internal communication interface for communication with the energy consumption unit/units and/or energy generation unit/units to which the relevant agent is assigned.

In order to allow simple access by a user to the settings of the agent, a preferred variant of the invention provides for each agent to comprise one or more user interfaces for accessing and setting parameters of the relevant agent.

In a further embodiment of the invention, the parameters of an agent can be checked in a particularly simple manner because a relevant agent automatically generates reports about its status. These reports can then be viewed by a user via corresponding user interfaces, for example.

In a particularly preferred embodiment of the invention, the negotiation of the monetary transactions is governed by a central unit. According to the invention, this is an energy exchange unit, which is preferably designed in such a way that it collects energy offers and energy requests from the agents and, on the basis of the offers and requests, arranges sales and purchases of energy between the agents. In this way, as a type of marketplace, a central trading platform is created on which the energy in the energy network is traded as a commodity. A suitable distribution of the energy in the energy network is therefore achieved in a simple manner by means of market mechanisms.

In order to perform the greatest possible number of transactions at a specific time in the energy network, a preferred embodiment provides for the energy exchange unit to be designed in such a way that it calculates an energy price at which the greatest number of monetary transactions takes place between the agents. This price is referred to as a market clearing price, and its calculation is explained further in the detailed description. The energy exchange unit then arranges the purchases and sales of energy on the basis of this energy price.

Furthermore, the energy exchange unit is preferably designed in such a way that the agents can access this unit in order to view the transactions arranged by the energy exchange unit. In order additionally to perform transactions outside of the network, a further embodiment of the invention provides for the energy exchange unit to be designed in such a way that it can contact energy exchange units of other energy networks, in order to provide energy to the other energy networks or to procure energy from them.

In order to prevent abuse when energy transactions and monetary transactions are performed, a preferred variant of the invention additionally provides a monitoring unit in the energy network. This unit monitors the performance of monetary transactions and the consequential provision and consumption of energy by the energy consumption units and/or energy generation units. According to the invention, the monitoring unit has the authority to initiate countermeasures if predefined criteria are present. Such criteria comprise, in particular, recognized cases of abuse or emergency situations. In the event of an energy shortage, for example, it must be ensured that the remaining available energy is first distributed to public units, e.g. hospitals, before it is provided to other industrial plants.

In a particularly preferred embodiment, the countermeasures which can be performed by the monitoring unit comprise the reduction and/or increase of the energy that is provided and/or consumed by a relevant energy consumption unit and/or energy generation unit. In particular, the countermeasure can even be the complete disconnection of a relevant energy consumption unit or energy generation unit. The countermeasure can also be the output of a corresponding command to reduce or increase the energy that is provided or consumed by a relevant energy consumption unit and/or energy generation unit.

In a further, preferred embodiment, the agents have electronic seals in each case to prevent tampering with the agents, wherein the monitoring unit preferably has the authority in this case to verify the electronic seals of the agents. Moreover, in a preferred embodiment of the invention, the monitoring unit has the authority to receive reports of suspected abuses and to perform and/or initiate investigations in respect of suspected abuses.

In a further, particularly preferred embodiment of the invention, a management unit for managing the energy consumption units and/or energy generation units belonging to the energy network, and their agents, is also provided in the energy network. In this case, the management unit is preferably designed in such a way that it registers and/or deregisters agents in the energy network. In this way, the number and details of energy consumption units or energy generation units participating in the energy network is stored in the management unit. In particular, the management unit is designed in such a way that it provides information about the energy network and allows the registering and/or deregistering of agents via an interface, in particular a web page.

One task of the management unit is preferably to monitor the energy consumption and energy generation of the energy consumption units and/or energy generation units, wherein energy bottlenecks or imbalances in the energy distribution result in countermeasures being specified by the management unit and corresponding instructions and/or recommendations being output to the agents by the management unit. In particular, the countermeasures can comprise a decoupling of the energy network from other energy networks and the output of instructions to the agents to increase the energy generation and/or reduce the energy consumption of the energy consumption units and/or energy generation units belonging to the agents. If appropriate, the management unit can additionally comprise analysis means for analyzing the energy distribution in the energy network, wherein corresponding statistics for subsequent evaluation can be generated on the basis of the analysis.

In a further embodiment, the management unit can offer technical advice services and/or services to promote the technical development of the energy network. The technical advice services can consist in, for example, allowing access to a web page on which corresponding information can be downloaded to assist the energy network user. A service for promoting the technical development can consist in defining programs via the management unit which prompt the users in the network, e.g. using monetary rewards, to develop better algorithms (e.g. for high-speed decoupling of the energy network) and make them available to the management unit.

In a further embodiment of the invention, the management unit establishes an interface to other energy networks, i.e. the management unit is designed in such a way that it can communicate with other energy networks, in particular with management units of other energy networks.

In addition to the above described decentralized energy network, the invention further relates to a method for distributing energy in such an energy network, wherein the distribution of the energy in the energy network is based at least partly on monetary transactions which are negotiated between the agents.

Exemplary embodiments of the invention are described in detail below with reference to the appended FIGURE, in which:

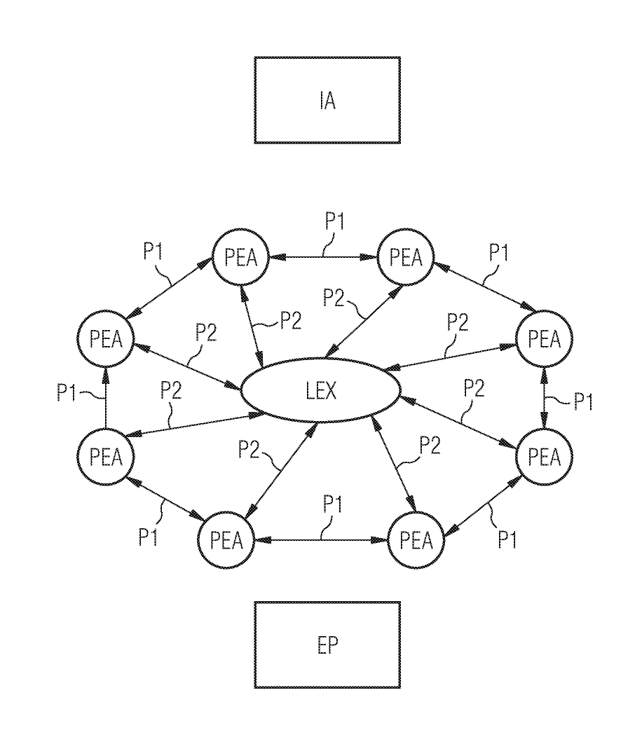

FIG. 1 shows a schematic illustration of an embodiment of an energy network according to the invention.

The following describes an embodiment of an energy network which distributes energy according to the principles of self-organization and decentralization. To this end, the energy network comprises a plurality of individual agents PEAs (PEA=Private Energy Agent), each of which is assigned to an energy generation unit and/or energy consumption unit in the network. In the following, the term PEA is generally also used as a synonym for the associated energy generation unit or energy consumption unit. In this case, the energy generation units are e.g. photovoltaic plants, wind turbines, Sterling engines and so-called CHP plants (CHP=Combined Heat and Power). The CHP plants can generate energy e.g. based on the combustion of diesel or on the combustion of hydrogen or hydrocarbons in fuel cells. The energy consumption units are in particular private households, commercial consumers (such as office buildings, public baths, etc.), and industrial consumers. If applicable, the energy consumption units and energy generation units can be combined units, which both consume energy and provide (surplus) generated energy to the network.

The energy network shown in FIG. 1 distributes the generated or consumed energy as uniformly as possible within the network, wherein surplus energy can also be provided to other networks or energy can also be obtained from other networks in the event of energy bottlenecks, if applicable. The outline conditions of this self-organizing energy distribution are firstly that the voltage and the frequency of the electrical energy that is provided must remain constant, and secondly that it must be possible to operate the network autonomously, i.e. independently of other energy networks. In order to achieve this, the PEAs are networked together in such a way that each PEA can communicate, i.e. exchange corresponding information, with another PEA. In addition, provision is further made for a central local energy exchange unit LEX which can be accessed by each PEA. In this context, the communication among the PEAs is indicated by means of corresponding arrows P1, whereas the communication of the individual PEAs with the energy exchange unit LEX is depicted by corresponding arrows P2. The communication among the PEAs is not limited to adjacent PEAs in this case, but each PEA can communicate with each PEA.

The distribution of energy in the energy network as per FIG. 1 is essentially market-based, in that the individual PEAs present their energy requirement or surplus energy as a commodity and perform monetary transactions on this basis, either among themselves or using an intermediate connection via the local energy exchange unit LEX. The local energy exchange unit LEX therefore essentially represents a switching unit for supply and demand of the individual PEAs which buy or sell energy in exchange for money. Since purely market-controlled distribution of the energy can possibly result in a significant imbalance in the energy distribution in the event of an emergency or abuse by the PEAs, provision is further made in the embodiment as per FIG. 1 for an administration unit IA (IA=Island Administration) and a monitoring unit EP (EP=Electricity Police), by means of which control mechanisms for energy distribution are provided in the case of emergencies or abuse, wherein said control mechanisms intervene in the purely market-based distribution of the energy. In this case, the management unit IA and the monitoring unit EP preferably represent public institutions which were selected by the PEAs belonging to the energy network in order to perform tasks which cannot be optimally controlled by pure market regulating mechanisms, such as e.g. monitoring the legal permissibility of a trade act for buying or selling energy, or decoupling the energy network illustrated in FIG. 1 from other networks.

There follows a detailed description of the tasks and functions of the individual components of the network as per FIG. 1, i.e. the agents PEAs, the energy exchange unit LEX, the management unit IA and the monitoring unit EP.

As explained above, the PEAs negotiate monetary transactions for providing or procuring energy among themselves or using an intermediate connection via the energy exchange unit LEX. In this case, the PEAs can be assigned to any energy generation units or energy consumption units, wherein the PEAs are divided into e.g. three classes. The first class relates to micro-PEAs, which are assigned to energy consumption units and/or energy generation units having a consumption capacity or generator capacity of 5 kW of less. The second class relates to mini-PEAs, which are assigned to energy consumption units and/or energy generation units having a consumption capacity or generator capacity of 30 kW or less. The third class relates to industrial PEAs, which are assigned to energy consumption units and/or energy generation units having a consumption capacity or generator capacity of 30 kW or more. The most important functions of a particular PEA can be divided into a total of seven function classes as follows:
measurement functions,
functions for controlling the energy flow,
user interface functions,
internal communication,
external communication,
reporting functions,
financial functions.

In this case, it is possible for only some of the functions to be realized in a PEA if applicable. In accordance with the measurement functions, the temporally distributed flow of the total energy and the flow of the energy for specific loads and generators is monitored and stored. Furthermore, statistical functions are implemented which calculate the average energy curve (load curve, energy generation curve) for an “average day” or an “average week”. In addition, the measurement functions provide energy quality functions, which monitor the quality of the supplied frequency, voltage, etc.

The PEA functions for controlling the energy flow allow a user of the PEA to parameterize specific prescribed load curves which are to be satisfied in the PEA. In addition, the user can program specific response mechanisms, which define how the PEA is to respond to significant deviations from a predefined energy consumption behavior. If the PEA comprises its own energy generators (e.g. wind generators, biomass generators, etc.), the PEA controls the balance between internal and external energy generation and energy consumption. In addition, a PEA has different energy reduction scenarios or energy disconnection scenarios, which are performed by the PEA if required and can be externally triggered by the administration unit IA or the monitoring unit EP, for example. These scenarios can be programmed individually if required.

The user interface functions of a PEA are implemented e.g. by an internal web server, which allows the parameterization of the PEA with the aid of a computer, in particular a commercially available PC. The external access to the PEA is also controlled with the aid of the user interface functions. In particular, the parameterization of the PEA can be delegated to a service provider who offers the management of the PEA as a service. The user interface functions additionally include alarm mechanisms which can be programmed to inform a user of the PEA if there are significant deviations from a predefined load behavior, which deviations result in e.g. very high energy costs due to non-compliance with a predetermined contract. The alarm can be implemented acoustically, optically, by sending an SMS, e-mail or in any other preferred way.

By means of the internal communication function, a PEA communicates with internal generators and loads via a standardized interface, via which it outputs e.g. commands to turn on a generator. The PEA can also communicate with so-called “intelligent” loads in order to reduce its power. For example, such an intelligent load can be a cooker which prevents a user from switching on a further hotplate if a hotplate is already active. Intelligent loads can also be realized in the form of an intelligent household, intelligent building management, or in the form of small and medium-sized intelligent industrial plants.

By means of the external communication function, a relevant PEA communicates with the energy exchange unit LEX in order to enter into a corresponding contract to buy or sell energy. The external communication can also take place directly between individual PEAs. Furthermore, each PEA features a communication interface to the management unit IA described below, e.g. in order to receive an instruction to reduce the load. Each PEA also communicates with the monitoring unit EP, which is described in further detail below. Corresponding security functions are also realized via the external communication function.

In accordance with the reporting functions, a PEA generates reports relating to the generation and consumption of energy, reports relating to individual events, reports relating to financial statistics, and reports containing recommendations for optimizing the PEA (e.g. recalibration of the load curve, flexible handling of the negotiation of contracts, etc.).

In accordance with the financial functions, a relevant PEA negotiates with other PEAs in order to buy correspondingly required energy or to sell a surplus of energy. The energy therefore represents a commodity, wherein this commodity is preferably traded via the energy exchange unit LEX. A further function of the PEA is the autonomous realization of energy contracts by arrangement via the energy exchange unit LEX or directly with other PEAs. Furthermore, a PEA preferably comprises optimization algorithms in order to reduce the costs when purchasing energy and to maximize the income when selling energy. In addition, further optimization mechanisms for negotiating the contracts are provided if applicable. The financial functions additionally include an electronic seal which secures the data that is relevant for the monetary trade acts, such that it cannot be tampered with by a user. Moreover, security functions are implemented in order to protect the data on the PEAs and prevent unauthorized access to said data.

As explained above, in particular, the autonomous realization of energy contracts should be accomplished by a PEA. This means that a PEA should trade autonomously in most cases. Under specified general rules which are predetermined by the PEA user, the PEA should be capable of managing standard situations for negotiating monetary transactions in relation to the buying and selling of energy.

If such standard situations deviate from predetermined profiles under specific conditions, the user is notified of this and can intervene manually. In order additionally to add further intelligent functionality to the elementary functionality of a PEA at a later time, a generic platform should be used for implementing the PEA.

A PEA can be realized in a similar manner to a DSL router, wherein an open-source operating system such as Linux, for example, is used to operate the PEA. A standard user only uses the standard functionality of the router in this case. Users having more experience can implement and dynamically adapt further functions based on the open-source operating system.

For the purpose of realizing an energy network as per FIG. 1, the operators/users of individual energy consumption units or energy generation units must be prepared to acquire a corresponding PEA. In particular, this is achieved if the energy generators encourage the energy consumers to us a PEA by providing cheaper energy tariffs when a PEA is installed by a consumer. In this case, the acquisition price of a PEA should relate to the annual energy consumption costs at a ratio of 1:1 to 2:1.

The user interface functionality of the PEA should be sufficiently sophisticated to provide reporting functionality, control functionality, etc. A large screen is therefore obligatory. Since this might result in a price which is no longer acceptable for the PEA, the possibility should also exist in particular for the PEA to be connectable to a commercial PC. The PEA should therefore be implemented as a web server.

The functionality of the energy exchange unit LEX is described in the following. A fundamental concept, on which the use of a LEX is based, is that an act of energy consumption or energy generation is assigned to each trade act. In this case, the PEA is an agent which trades in the name of the corresponding consumer or generator to which the PEA is assigned. In addition to local functions relating to the measurement and control of the local demand for energy and supply of energy, a LEX should also be able to act outside of the market assigned to the local energy network, in order to buy or sell energy. However, the main task of the LEX is to provide a platform for the local market of the individual PEAs of the energy network as per FIG. 1. In this case, the LEX is preferably implemented as a web server which the PEAs can access via standardized protocols. The most important functions of the LEX are as follows:
collecting offers and requests,
calculating a so-called market clearing price,
realizing contracts,
displaying trading activities on a web page,
negotiating with other and larger LEXs, in order to make provision for oversupply or supply shortage of energy,
generating reports for energy generators and energy consumers.

In this case, it is possible for only some of the functions to be realized in a LEX if applicable.

In order to realize the functionality of collecting offers and requests, provision is made for a standardized interface via which the PEAs contact the LEX. They can query the current market clearing price and submit offers relating to the purchase and sale of energy, and request the current status of trade acts.

In accordance with the functionality for calculating the market clearing price, the LEX calculates that price which, according to the offers and demand for energy, results in the greatest number of monetary transactions for the purchase and sale of energy. In this case, said market clearing price is determined as follows:

It is assumed that, at a given time t, a total of Nᵢ PEAs wish to buy a total quantity of nᵢ electricity (in kWh) at a price of pᵢ. These PEAs would naturally also buy the same quantity of energy/electricity at a lower price. At a predetermined price pₖ/therefore, a total quantity of electricity would be bought as follows:

$${E}_{{p}_{k}} = {\sum }_{i = k}^{∞} {n}_{i} .$$

In this context, all of the prices greater than pₖ are accumulated, i.e. the prices are ordered as follows:

pᵢ₋₁<pᵢ<pᵢ₊₁.

Conversely, at a given time t, a number Aⱼ of PEAs wish to sell a total quantity of electricity aⱼ at a price pⱼ or higher. The total quantity of energy which is ultimately sold at a price pₖ is then as follows:

$${E}_{{p}_{i}} = {\sum }_{j = 0}^{k} {a}_{j} .$$

On the basis of these aggregated offers and requests, it is then possible to calculate the market clearing price p_{MCP} at which the greatest number of transactions is performed. Assuming a continuous representation of the price, this market clearing price is produced when the following condition is satisfied:

$${\int }_{{p}_{MCP}}^{∞} n ( p ) d p = {\int }_{0}^{{p}_{MCP}} a ( p ) d p .$$

The calculation of this market clearing price is performed by the LEX, and the monetary transactions are then arranged between the individual PEAs on the basis of this price.

In order that the LEX can realize the corresponding monetary transactions, the LEX itself contains a broker function, i.e. each PEA can access the LEX directly, without a further trader being connected between them. The LEX should therefore have banking authorizations and be able to enter into the corresponding purchase contracts, and should also be able to manage the bank accounts of the PEAs. If applicable, a LEX can also be realized as an interregional energy exchange unit, in order to allow energy exchange between individual local energy networks as shown in FIG. 1. To this end, an intermediate layer can be provided between the PEA and the LEX in the form of an energy trader if applicable.

In order to make trading activities visible to PEAs, such activities are reported on a web page which can be visited by the individual consumers or energy generators. This page can therefore be a platform for stimulating new market developments, informing consumers, and notifying consumers of trends and estimates.

Furthermore, a LEX can also contact other or larger LEXs in certain circumstances, in particular if there is a local requirement for energy or a local surplus of energy. The LEX can then offer the energy surplus to other LEXs or buy energy from other LEXs. The LEX therefore arranges contracts between contract partners which are located remotely from each other.

The aforementioned reporting functionality of the LEX is particularly important because the PEAs work in a very autonomous manner. The reason for this is that a user often desires a high degree of automation for a commodity such as electricity. Using the reporting functionality, a user can therefore check which quantities of energy were purchased from whom and what prices were paid in respect of this.

The LEX can additionally feature security functionality. This security functionality should correspond to the security requirements of the PEAs, since the LEX is a communication partner of the PEAs.

The functionality of the monitoring unit in the form of the electricity police EP is explained below. In this case, it must be taken into consideration that electrical energy as a commodity is different from other commodities, in that electrical energy cannot be differentiated. The seller of electricity cannot furnish the transferred electricity quantity with corresponding identification codes which unambiguously specify the source of the energy. There is therefore no intermediate entity which can trace the transfer of an energy packet. Instead, each seller places the sold energy quantity which they produced into a shared pool, and the consumer takes a corresponding energy quantity from the pool in accordance with the certificate used by the consumer to purchase the energy quantity. Consequently, there are essentially two different types of opportunity for fraud:
The seller sells energy which was not placed into the pool by said seller.
The consumer takes energy from the pool without paying for it.

There is therefore a need for an inspection entity which is authorized to verify the legitimacy of trade acts and is also authorized to intervene in corresponding cases of fraud. This institution is the monitoring unit EP shown in FIG. 1. This monitoring unit can be realized as a web server, for example. The underlying functionality of this unit is as follows:
monitoring trade acts,
verifying that contracts have been satisfied,
performing measurements to trace energy bottlenecks,
access rights to the PEAs,
verifying the integrity of the electronic seal of a PEA,
authority to instruct a disconnection or power reduction of an energy generator or energy consumer,
authority to force a disconnection or power reduction of an energy generator or energy consumer,
receiving reports of suspected abuse,
performing investigations in respect of suspected abuse.

In this case, it is possible for only part of the functionality to be realized in an EP.

The functionality for monitoring the trade acts ensures the legitimacy of each trade act. This is done by means of each trade act being notified to the monitoring unit, wherein the notification comprises the traded energy quantity and the time of production or consumption. The monitoring unit inserts this trade act into an overall time plan. When the time for realizing the trade act is reached, the monitoring unit performs measurements of both energy generation and energy consumption, in order to verify that the trade act was performed correctly.

The functionality for performing measurements to trace energy bottlenecks is used to identify those energy bottlenecks which are not caused by abuse. Such energy bottlenecks may be caused, for example, by incorrect calibration of measuring devices, line losses, etc. Accurate measurements at various locations, in particular at energy plants for balancing the energy, are the basis for checking the system accurately and for detecting all types of technical problem.

In accordance with the functionality of access to the PEAs, the monitoring unit has the exclusive right to access the PEAs with or without a corresponding court ruling and depending on the situation concerned. Standard access to the relevant PEA is provided for monitoring trade acts. This access is protected by a cryptographic mechanism, such that only the monitoring unit can access this data.

In accordance with the functionality of verifying the electronic seal of a PEA, the monitoring unit can access the PEA in order to verify the integrity of this seal. In this context, the seal protects the PEA data area containing the trade-related information.

Since the monitoring unit performs a multiplicity of measurements, it can rapidly detect problems in the provision of or demand for electrical energy. In order to anticipate losses which could affect larger public institutions such as hospitals, public facilities, etc., the monitoring unit has the functionality to order disconnection or a reduction in the power of energy consumers or energy generators. According to the invention, the PEAs implement mechanisms for responding appropriately to such commands. Such commands can include time delays, can be attached to conditions, and can be prioritized.

In emergencies, when it is necessary to prevent losses, the monitoring unit is additionally able to output an unconditional command. This command comprises inter alia an increase in the power or a special increase or decrease in the power or a disconnection of the power of individual consumers or energy generators. For example, the disconnection of television viewers can be forced because a heavy electrical device must remove a tree from railway tracks.

In accordance with a further functionality, the monitoring unit is also used to receive reports relating to suspected fraud.

In cases of suspected fraud in the energy network itself, the monitoring unit can additionally be authorized to perform investigations. Said investigations can be initiated by web robots, for example. The management unit can also be used merely to trigger investigations, wherein the actual investigations are undertaken by human users.

When implementing the monitoring unit, various security considerations must be taken account of in order to realize the functionality of a policing entity. These considerations relate inter alia to the provability of fraudulent practice, i.e. provision must be made for means whereby an agent in the network, who carried out a specific action, cannot deny the authorship of this action.

The functionality of the management unit IA shown in FIG. 1 is explained below. In accordance with the energy network as illustrated in FIG. 1, the participating PEAs form a type of “island” which is managed by the management unit IA. The significance of such an island is that, in the event of problems which originate in far distant locations of the island, the “inhabitants of the island” (representing the PEAs) have the ability to decouple from the “rest of the world” and solve their energy problems independently. Such a far distant cause could be, for example, the disconnection of a high-voltage line in another country. The possibility of decoupling implies that the capacities for energy generation and energy demand on the island are balanced out. The principle of the island is one of “self-similarity”, i.e. islands of any possible power class can be realized, through to an individual household. Provided every household or at least a majority of a household possesses a type of energy generation (e.g. a photovoltaic roof), the operation of the island on this very small scale is possible at least for a specific time.

According to the invention, the management unit IA represents a unit which assumes administrative tasks for each island of PEAs, and implements the necessary administrative structures. In particular, such a management unit comprises the following functions:
registering and deregistering PEAs with the management unit,
managing a web page of information about the island,
performing a decoupling of the island,
monitoring power imbalances,
technical advice services,
analysis,
technical development of the island,
communication with other islands.

In this case, it is possible for only some of the functions to be realized in an IA if applicable.

In accordance with the functionality of registering or deregistering, a new consumer can register with a management unit. A plurality of management units can be active in a predetermined geographical area if applicable. The advantage of registering with a management unit is that, in the event of a far distant power failure, the individual registered unit is integrated in a larger context, such that the operation of the unit after such an event is suitably ensured. Competition between individual management units is naturally desirable and it is therefore also possible for the PEAs to deregister from a management unit.

The management unit uses a web page to provide information about the number and capacities of the energy consumers or energy generators belonging to an island. The web page also allows access to the registration process. Furthermore, information is provided about the rules that have been specified for the island, e.g. which actions are performed if an island decouples, how the management unit handles the market-based distribution of energy, etc.

The process of decoupling the island is initialized by the management unit particularly if a far distant power failure occurs which affects the energy supply of the PEAs on the island.

For the purpose of decoupling the island, the management unit has the authority to stipulate energy controls for the energy generators and energy consumers. The management unit includes a database which contains information relating to the flexibility of the different energy generators and energy consumers. This information can be automatically collected at an early stage by means of communication between the management unit IA and the PEAs. For example, if the external energy supply reaches a level of 30% and the suddenly fails completely, the management unit instructs the energy consumers immediately to reduce their energy consumption correspondingly. The management unit then ascertains the energy generation capacity within the island, and instructs the energy generators to assume responsibility for the generation of energy that is required correspondingly. In principle, such a failure of an external energy supply could also be controlled via the market. However, the danger then exists that industrial plants compete with hospitals for the acquisition of energy. It is therefore beneficial to balance out the mechanisms of the free market by the management unit, which functions according to recognized action plans in the event of emergency situations.

In order to maintain the stability of voltage and frequency in the energy network, conventional energy networks usually feature energy equalization plants which compensate for poor estimates of line losses, incorrect implementation of contracts, inaccurate measurements, etc. Such equalization plants always result in additional losses. In order to minimize the use of such energy equalization plants, the management unit traces any non-uniform distribution of energy, e.g. with the aid of the monitoring unit EP, which identifies the causes thereof. The management unit then proposes corresponding measures for overcoming the problem. The management unit also offers technical advice services for the individual PEAs in respect of energy-related products, energy-saving possibilities, etc.

Furthermore, the management unit performs analyses on the basis of the data which is measured during operation of the energy network. These analyses are used to generate statistics which allow corresponding measures to be defined in order to improve the energy supply situation of the overall network or of individual energy generators and energy consumers.

The management unit can also support the technical development of the energy network by specifying corresponding programs. Of course, this can also be performed solely on the basis of the mechanism of the free market. However, the focus of the technical development is on features which relate solely to the management unit, e.g. the development of better algorithms to allow rapid decoupling of the energy network.

The management unit also makes it possible to communicate with other energy networks, thereby allowing the implementation of corresponding measures for collaboration with other networks.

The security requirements at the management unit IA are similar to the security requirements at the monitoring unit EP, because the management unit represents a public entity and has specific execution rights in a similar manner to the monitoring unit. It is therefore essential to prevent dangerous actions which could possibly be performed by the management unit, e.g. the erroneous disconnection of an industrial plant from the energy network by the management unit. The management unit can also be the target of attack by hackers. Access control in the management unit is therefore an important security requirement.

1-25. (canceled)

26. A decentralized energy network, comprising:
a plurality of energy consumption units and/or energy generation units;
a plurality of agents, with at least one said agent assigned to each said energy consumption and/or energy generation unit;
said agents being networked together in such a way to enable each said agent to communicate with other said agents in the energy network; and
wherein a distribution of energy in the energy network is based at least partly on monetary transactions negotiated between said agents.

27. The energy network according to claim 26, wherein the energy network is configured to procure energy from other energy networks and/or to feed energy to other energy networks.

28. The energy network according to claim 26, wherein each said agent comprises a transaction unit configured to automatically negotiate prices with other said agents for providing and/or procuring energy, and to enter into corresponding contracts.

29. The energy network according to claim 26, wherein a respective said agent comprises an energy measurement unit and/or energy control unit for measuring and/or controlling the energy that is consumed or provided by the respective said energy consumption units and/or energy generation units.

30. The energy network according to claim 26, wherein each said agent comprises one or more communication interfaces.

31. The energy network according to claim 30, wherein said one or more communication interfaces include an external communication interface for communicating with other said agents and an internal communication interface for communicating with the energy consumption unit/units and/or energy generation unit/units to which said agent is assigned.

32. The energy network according to claim 26, wherein each said agent comprises one or more user interfaces for accessing and setting parameters of the respective said agent.

33. The energy network according to claim 26, wherein said agents are configured to automatically generate reports relating to a status thereof.

34. The energy network according to claim 26, which comprises a local energy exchange unit through which said agents negotiate the monetary transactions during an operation of the energy network.

35. The energy network according to claim 34, wherein said energy exchange unit is configured to collect energy offers and energy requests from said agents and to arrange purchases and sales of energy between said agents on a basis of the offers and requests.

36. The energy network according to claim 34, wherein said energy exchange unit is configured to calculate an energy price at which a greatest number of monetary transactions takes place between said agents, and to arrange purchases and sales of energy on a basis of the energy price thus calculated.

37. The energy network according to claim 34, wherein said energy exchange unit is accessible to said agents for viewing transactions arranged by said energy exchange unit.

38. The energy network according to claim 34, wherein said energy exchange unit is configured to contact energy exchange units of other energy networks in order to provide energy to the other energy networks or to procure energy from the other energy networks.

39. The energy network according to claim 26, which comprises a monitoring unit configured to, during operation of the energy network, monitor a performance of the monetary transactions and a consequential provision and consumption of energy by the energy consumption units and/or energy generation units, and said monitoring unit being authority to access the relevant said agents and initiate countermeasures if predefined criteria are present.

40. The energy network according to claim 39, wherein the countermeasures are selected from the group consisting of a reduction and/or an increase of the energy provided and/or consumed by a relevant energy consumption unit and/or energy generation unit, and/or an output of a corresponding command to reduce and/or increase the energy that is provided or consumed by a relevant energy consumption unit and/or energy generation unit.

41. The energy network according to claim 39, wherein said agents comprise electronic seals to prevent tampering therewith, and said monitoring unit is authorized to verify said electronic seals of said agents.

42. The energy network according to claim 39, wherein said monitoring unit is authorized to receive reports of suspected abuses and to initiate and/or carry out investigations in respect of suspected abuses.

43. The energy network according to claim 26, which comprises a management unit for managing the energy consumption unit and/or energy generation unit belonging to the energy network, and said agents assigned to the respective said unit.

44. The energy network according to claim 43, wherein said management unit is configured to register and deregister respective said agents in the energy network.

45. The energy network according to claim 43, wherein said management unit is configured to provide information about the energy network and to allow registering and/or deregistering respective said agents via an interface.

46. The energy network according to claim 45, wherein the interface is a web page.

47. The energy network according to claim 43, wherein said management unit is configured to monitors the energy consumption and energy generation of the energy consumption units and/or energy generation units and, in an event of energy bottlenecks and/or imbalances in the energy distribution, to specify countermeasures and to output corresponding instructions and/or recommendations to said agents.

48. The energy network according to claim 47, wherein the countermeasures include a decoupling of the energy network from other energy networks and an output of instructions to the agents to increase an energy generation and/or reduce an energy consumption of the energy consumption unit and/or energy generation unit belonging to the respective said agents.

49. The energy network according to claim 43, wherein said management unit comprises analysis means for analyzing an energy distribution in the energy network.

50. The energy network according to claim 43, wherein said management unit is configured to offer technical advice services and/or services to promote a technical development of the energy network.

51. The energy network according to claim 43, wherein said management unit is configured to communicate with other energy networks.

52. The energy network according to claim 51, wherein said management unit is configured to communicate with management units of the other energy networks.

53. A method of distributing energy in an energy network, which comprises:
providing an energy network according to claim 26; and
distributing the energy in the energy network at least partly on a basis of monetary transactions that are negotiated between the agents.
